(19) United States
(12) Patent Application Publication
(10) Pub. No.: US 2016/0347341 A1
(43) Pub. Date: Dec. 1, 2016

(54) CART

(71) Applicant: ASHER ROBERT TAUBER, HASHMONAIM (IL)

(72) Inventor: ASHER ROBERT TAUBER, HASHMONAIM (IL)

(21) Appl. No.: 15/163,697

(22) Filed: May 25, 2016

(30) Foreign Application Priority Data
May 28, 2015 (IL) 239086

(51) Int. Cl. B62B 3/02

(52) U.S. Cl. CPC B62B 3/027

(57) ABSTRACT

A cart including: a basket, being supported by a basket support, the basket including side walls, for carrying contents; legs for sufficiently supporting the basket support, and extending therefrom, and being vertically rotatable in relation thereto; at least one locking element, for locking the legs to the basket support, for normally disallowing rotating the legs in relation to the basket support, for normally maintaining the cart unfolded; and a mechanism, for canceling the locking, thereby the vertical rotation of the legs in relation to the basket support, is applicable upon the canceling of the locking, thereby the cart allows a single-step collapsing thereof.

### CROSS-REFERENCE TO RELATED APPLICATIONS

This application claims the benefit of priority from Israel Patent Application No. 239086, filed May 28, 2015, the disclosure of which is incorporated herein by reference.

### TECHNICAL FIELD

The invention relates to the field of carts and shopping carts. More particularly, the invention relates to a cart and method for inserting thereof into a vehicle.

### BACKGROUND

U.S. Pat. No. 7,080,844 discloses a basket with a lift mechanism that raises the unit to the cargo floor height of the vehicle, and also used to lower the basket to a comfortable working height for the user while shopping. The basket dimensions take into account the space limitations inside the vehicle's cargo area while providing the optimum basket capacity. A slide mechanism includes a frame member, a set of guide rails, a plurality of wheels and rollers to guide the basket and frame assemblies into and out of the vehicle. A plurality of legs and base frame members connected by a plurality of cross members and hinges that are foldable to a compact arrangement and fits in place alongside the basket inside the vehicle. The length of the legs when unfolded should conform to the cargo load height of the vehicle. The legs can be made adjustable in length to compensate for varying cargo load heights of various vehicle makes and models.

However, this mechanism is cumbersome.

US20080303248 and WO2005028277 disclose a portable shopping cart with foldable front legs and retractable back legs that permits the shoppers to easily unload the cart from the back of their Mini-van or SUVS and load it back to the vehicle, filled with groceries, with a minimum effort. The top part is a plastic rectangular basket or container with inside compartments that will permit the proper separation of different types of products so these will be well protected. It also includes some removable containers that fit in some of the compartments and are made of thermal materials to keep the dairy food and fresh food in good condition while is being transported. The basket is mounted on a metallic frame that holds the two sets of legs with wheels. The front of the basket is also equipped with a set of two wheels intended to hold the front of the cart and guide it inside the vehicle while the front legs are folded. The two front legs fold when the cart is pushed inside the vehicle and open when the cart is pulled out of the vehicle. The two back legs are telescopic designed to be retracted inside the basket when the cart is pushed in to the vehicle, and drop down when the cart is pulled out of the vehicle, by a spring mechanism. U.S. Pat. No. 5,649,718 discloses automatic leg folding.

However, the rear legs require additional manual operation for folding thereof.

### SUMMARY

In one aspect of the invention, the invention provides a method and apparatus for folding the shopping cart by an immediate approach, such that the user doe not have to intervene in the folding process.

In one aspect, the invention is directed to a cart including:

a basket, being supported by a basket support, the basket including side walls, for carrying contents;

legs for sufficiently supporting the basket support, and extending therefrom, and being vertically rotatable in relation thereto;

at least one locking element, for locking the legs to the basket support, for normally disallowing rotating the legs in relation to the basket support, for normally maintaining the cart unfolded; and

a mechanism, for canceling the locking, thereby the vertical rotation of the legs in relation to the basket support, is applicable upon the canceling of the locking,

thereby the cart allows a single-step collapsing thereof.

### BRIEF DESCRIPTION OF DRAWINGS

Embodiments, features, and aspects of the invention are described herein in conjunction with the following drawings:

FIG. 1 is a perspective view of a shopping cart according to one embodiment of the invention.

FIG. 2 is a magnification of a portion of the shopping cart of FIG. 1, from a different angle of view.

FIG. 3 is a magnification of the portion of FIG. 2, from a different angle of view.

FIG. 4 is a side view of the shopping cart of FIG. 1, prior to being inserted into a vehicle, according to one embodiment.

FIG. 5 is a side view of the shopping cart of FIG. 1, at the second step.

FIG. 6 is a side view of the shopping cart of FIG. 1, at the third step.

FIG. 7 is a perspective view of shopping cart of FIG. 6 at the third step.

FIG. 8 is a magnified portion of FIG. 7, from one angle of view.

FIG. 9 is another magnified portion of FIG. 7, from another angle of view.

FIG. 10 depicts additional features of the shopping cart of FIG. 1.

FIG. 11 is a perspective view of the shopping cart of FIG. 1, prior to being inserted into a vehicle, according to another embodiment.

FIG. 12 is a side view of the shopping cart of FIG. 1, at the second step, regarding the embodiment of FIG. 11.

FIG. 13 is a side view of the shopping cart of FIG. 1, at the third step, regarding the embodiment of FIG. 11.

FIG. 14 is a side view of the shopping cart of FIG. 1, at the fourth step, regarding the embodiment of FIG. 11.

FIG. 15 is a side view of the shopping cart of FIG. 1, at the fifth step, regarding the embodiment of FIG. 11.

FIG. 16 is a top perspective view of the height compensating accessory alone, of FIG. 11.

FIG. 17 is a bottom perspective view of the height compensating accessory alone, of FIG. 11.

FIG. 18 is a perspective view of the shopping cart of FIG. 1, at the sixth step, regarding the embodiment of FIG. 11.

FIG. 19 is a perspective view of the shopping cart of FIG. 1, at the seventh step, regarding the embodiment of FIG. 11.

FIG. 20 is a perspective view of the shopping cart of FIG. 1, at the eighth step, regarding the embodiment of FIG. 11.

FIG. 21 is a perspective view of the shopping cart of FIG. 1, at the ninth step, regarding the embodiment of FIG. 11.

FIG. 22 is a top view, for depicting the problem of inserting the shopping cart of FIG. 1 through the side opening of the vehicle, depicted in FIG. 4.

FIG. 23 is a top view depicting the solution to the problem of FIG. 22.

FIG. 24 is a perspective view of the cart of FIG. 23.

FIG. 25 is a top perspective view of a mechanism for rotating the basket in relation to the basket support.

FIG. 26 is a bottom perspective view of the mechanism of FIG. 25.

FIG. 27 depicts the functions of the mechanism of FIGS. 25 and 26.

The drawings are not necessarily drawn to scale.

### DETAILED DESCRIPTION

The invention will be understood from the following detailed description of preferred embodiments of the invention, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

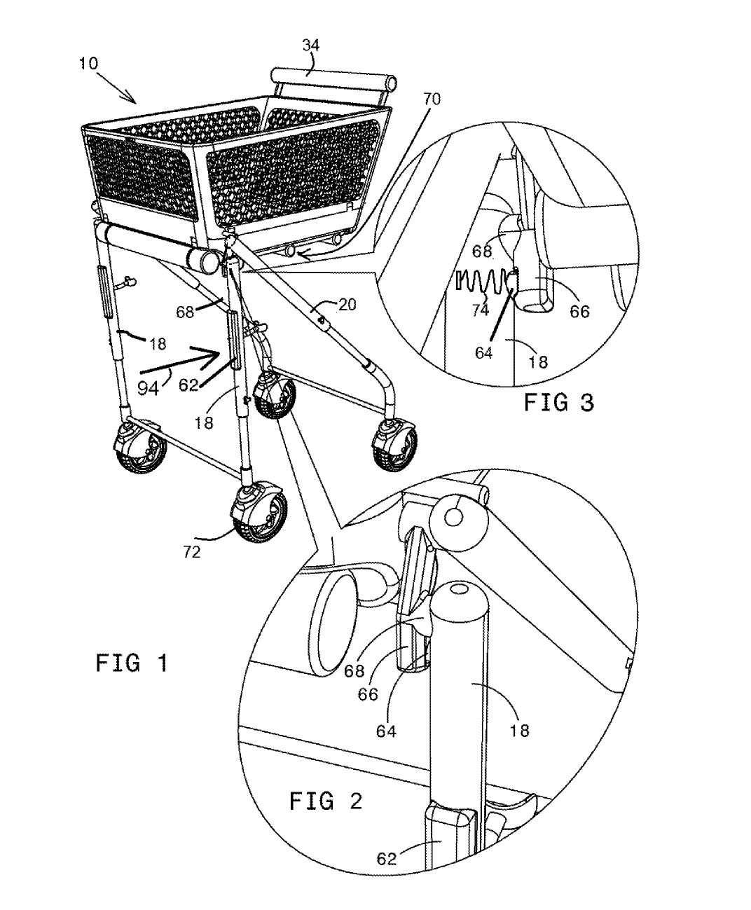

FIG. 1 is a perspective view of a shopping cart according to one embodiment of the invention.

A cart 10, such as a shopping cart, a stroller, etc., includes legs 18 and 20 extending from a basket support 70, and wheels 72 extending from legs 18 and 20.

FIG. 2 is a magnification of a portion of the shopping cart of FIG. 1, from a different angle of view.

Legs 18 and 20 are vertically rotatable in relation to basket support 70, as legs 18 are connected to basket support 70 through a horizontal hinge 68. However, in the normal state, depicted in FIGS. 1 and 2, a locking element 64 extends from leg 18 into a bar 66 extending from basket support 70, for not allowing legs 18 to rotate in relation to bar 66 and in relation to basket support 70.

FIG. 3 is a magnification of the portion of FIG. 2, from a different angle of view.

A spring 74 presses locking element 64 into bar 66, for maintaining the state of not allowing legs 18 to rotate in relation to bar 66 and in relation to basket support 70.

Legs 18, once pressed or knocked horizontally, as shown by horizontal arrow 94, fold shopping cart 10.

According to one embodiment, a button 62 once pressed horizontally, as shown by horizontal arrow 94, may press locking element 64 out of bar 66, against the force of spring 74, for allowing rotating leg 18 for folding shopping cart 10.

According to another embodiment, knocking on leg 18 horizontally, as shown by horizontal arrow 94, rather than pressing thereon, releases locking element 64 out of bar 66, for allowing vertically rotating leg 18 for folding shopping cart 10.

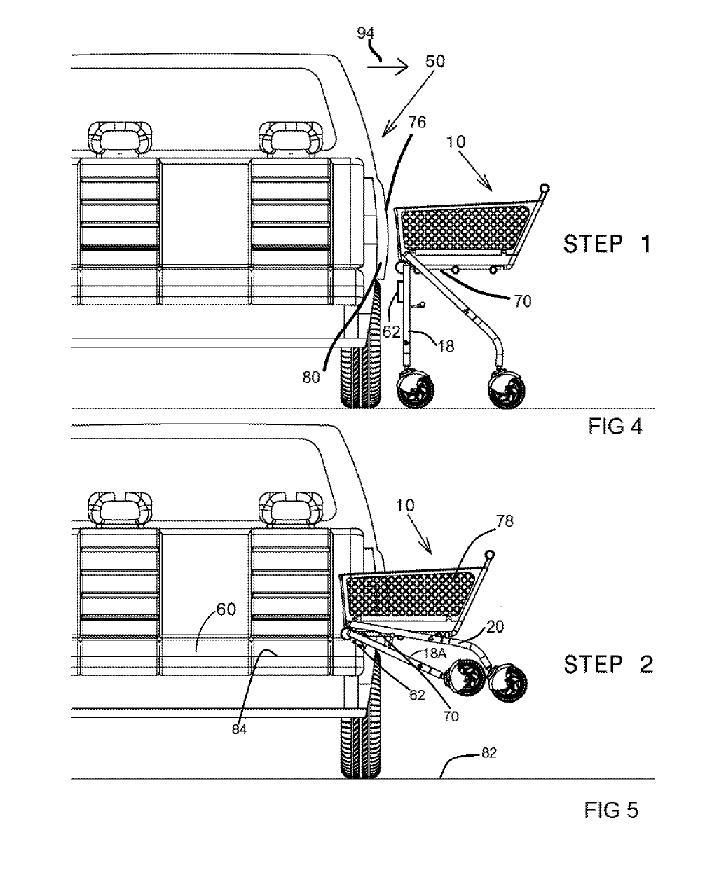

FIG. 4 is a side view of the shopping cart of FIG. 1, prior to being inserted into a vehicle, according to one embodiment.

According to one embodiment shopping cart 10 may be inserted into a vehicle 50 through the side opening of the vehicle 50.

At the first step, shopping cart 10 is placed adjacent to the side of vehicle 50.

FIG. 5 is a side view of the shopping cart of FIG. 1, at the second step.

At the second step, upon pressing shopping cart 10 onto the side wall 80 of vehicle 50, horizontally, as shown by horizontal arrow 94, side wall 80 of vehicle 50 presses button 62 of shopping cart 10, and further presses or knocks legs 18. Consequently, legs 18 and 20 vertically rotate in relation to basket support 70 and in relation to the basket 78 of shopping cart 10, thus folding shopping cart 10.

Basket 78 of shopping cart 10 does not collapse on the ground 82, in spite of the folding, since the vehicle seat 84 supports the bottom of shopping cart 10 including basket support 70 and legs 18. Thus, shopping cart 10 collapses within the cabin of the vehicle.

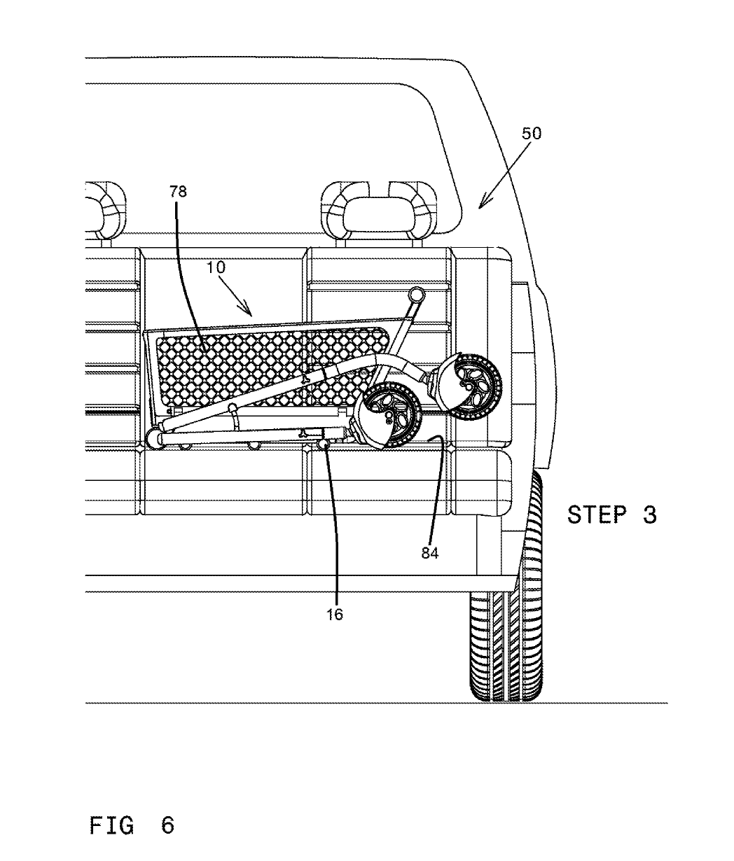

FIG. 6 is a side view of the shopping cart of FIG. 1, at the third step.

At the third step, the user further presses shopping cart 10 into vehicle 50 along seat 84, completing the folding of legs 18 and 20.

Wheels or cylinders 16, disposed at the bottom of basket support 70, may accompany the pressing of shopping cart 10 into vehicle 50, and further out of vehicle 50.

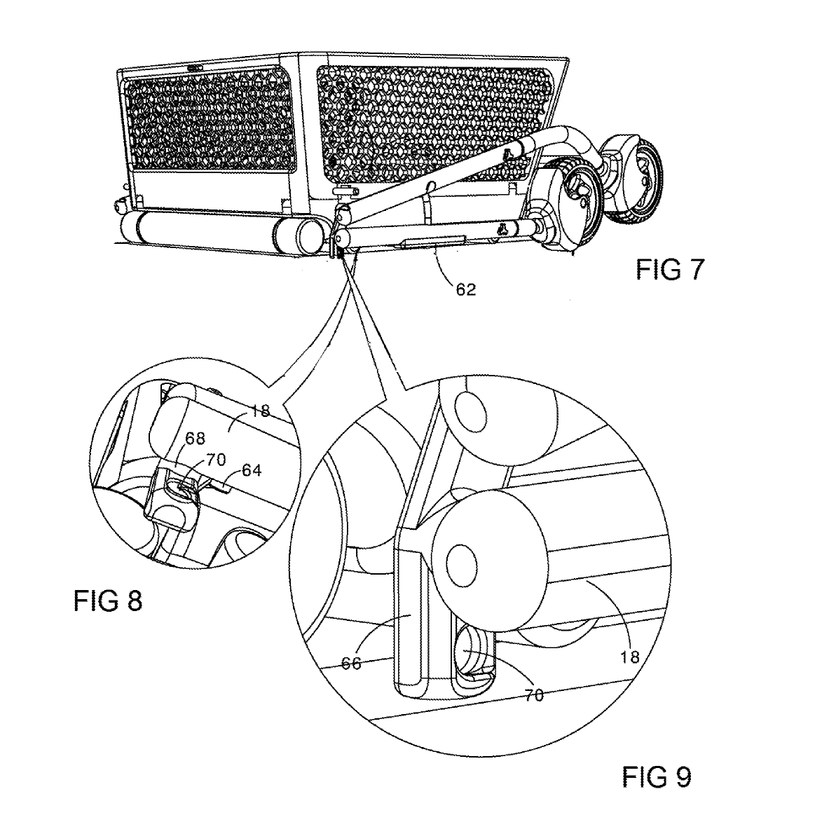

FIG. 7 is a perspective view of shopping cart of FIG. 6 at the third step.

FIG. 8 is a magnified portion of FIG. 7, from one angle of view.

FIG. 9 is another magnified portion of FIG. 7, from another angle of view.

At the folded state, locking element 64 is disposed within log 18, leaving a depression 70 in bar 66, within which locking element 64 was housed in FIGS. 2 and 3.

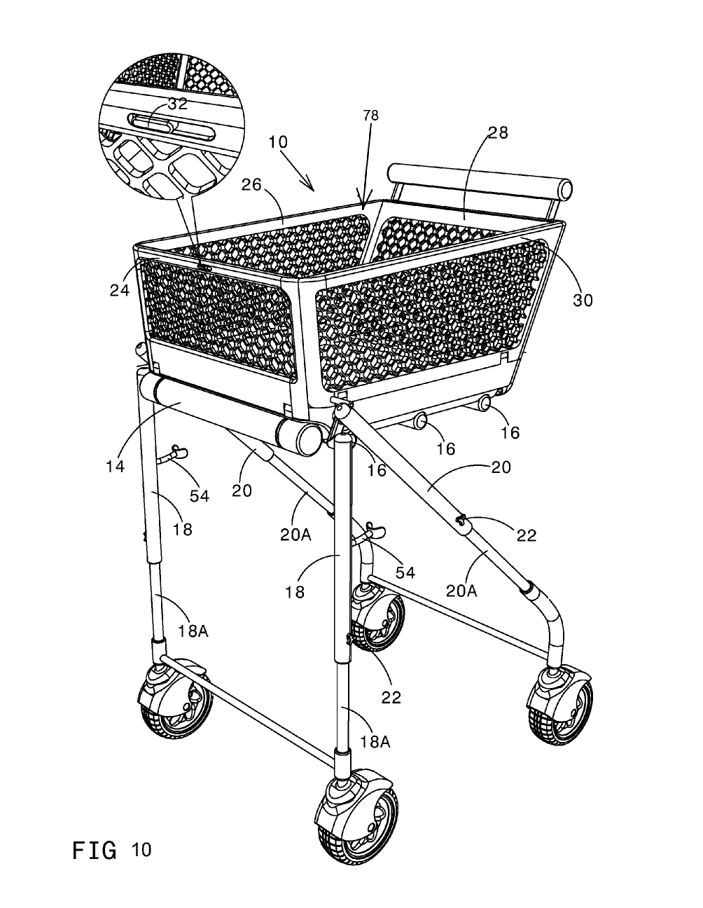

FIG. 10 depicts additional features of the shopping cart of FIG. 1.

Basket 78 may include a button 32 for folding walls 24, 26, 28 and 30 of basket 78 one towards the other.

Leg 18 may be extendable by retracting a telescopic extension 18A. Leg 20 may be extendable by retracting a telescopic extension 20A. Rotatable buttons 22 may adjust the extent of the extension.

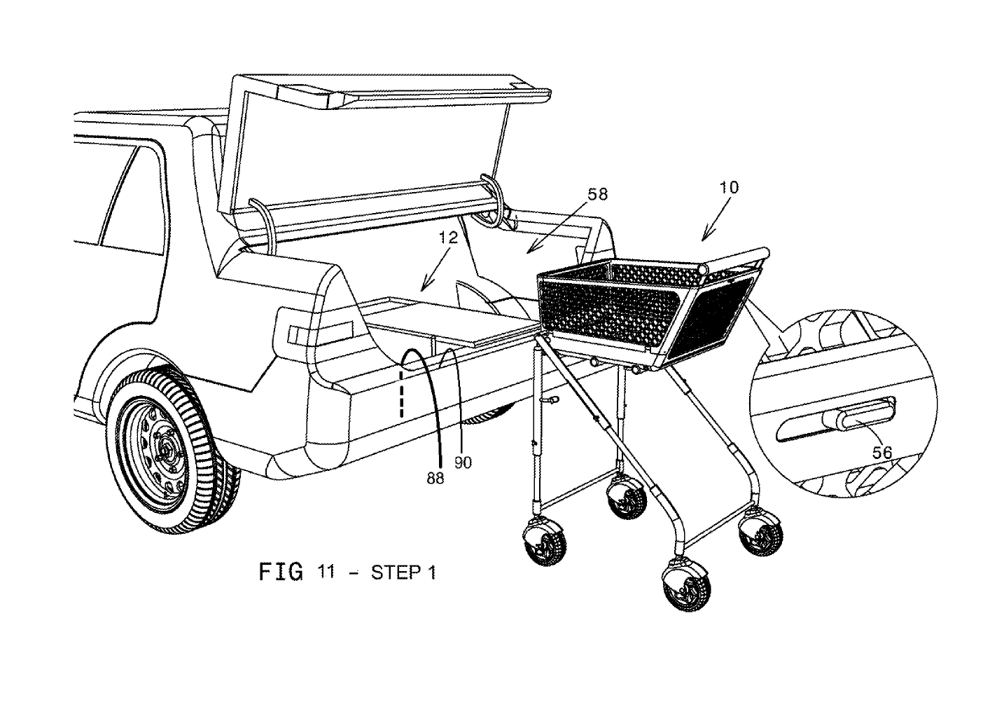

FIG. 11 is a perspective view of the shopping cart of FIG. 1, prior to being inserted into a vehicle, according to another embodiment.

According to another embodiment, shopping cart 10 may be inserted into the rear compartment 58 of vehicle 50 through the rear opening of the vehicle.

The extendibility feature of legs 18 and 20 is essential for allowing changing the insertion from the side to the rear, since insertion from the rear of the vehicle requires longer legs 18 and 20.

In order to compensate height difference between the height of bottom surface 88 of vehicle rear compartment 58, being lower than the bottom 90 of the opening of rear compartment 58, shopping cart 10 may include a height compensating accessory 12.

At the first step of this embodiment, height compensating accessory 12 is placed on bottom surface 88 of vehicle rear compartment 58.

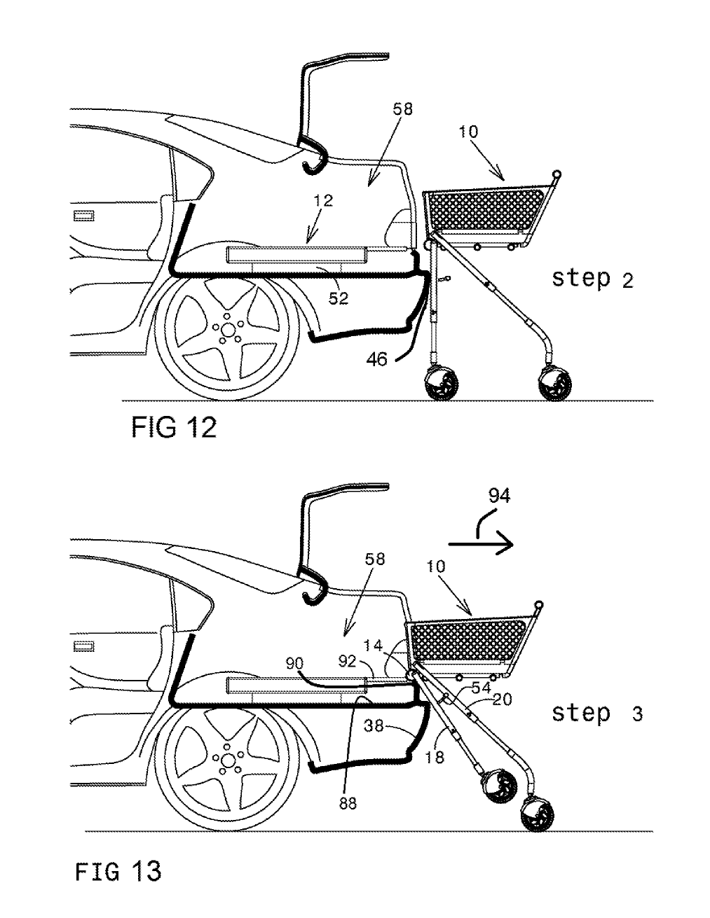

FIG. 12 is a side view of the shopping cart of FIG. 1, at the second step, regarding the embodiment of FIG. 11.

At the second step, shopping cart 10 is placed adjacent to the side of vehicle 50.

FIG. 13 is a side view of the shopping cart of FIG. 1, at the third step, regarding the embodiment of FIG. 11.

At the second step, being upon pressing shopping cart 10 onto the side wall 80 of vehicle 50, horizontally, as shown by horizontal arrow 94, rear wall 46 of vehicle 50 presses button 62 (not shown) of shopping cart 10, and further presses or knocks legs 18. Consequently, legs 18 and 20 vertically rotate in relation to basket support 70 and in relation to the basket 78 of shopping cart 10, thus folding shopping cart 10.

Basket 78 of shopping cart 10 does not collapse on the ground, in spite of the folding, since the top surface 92 of height compensating accessory 12 supports the bottom of shopping cart 10 including basket support 70 and legs 18.

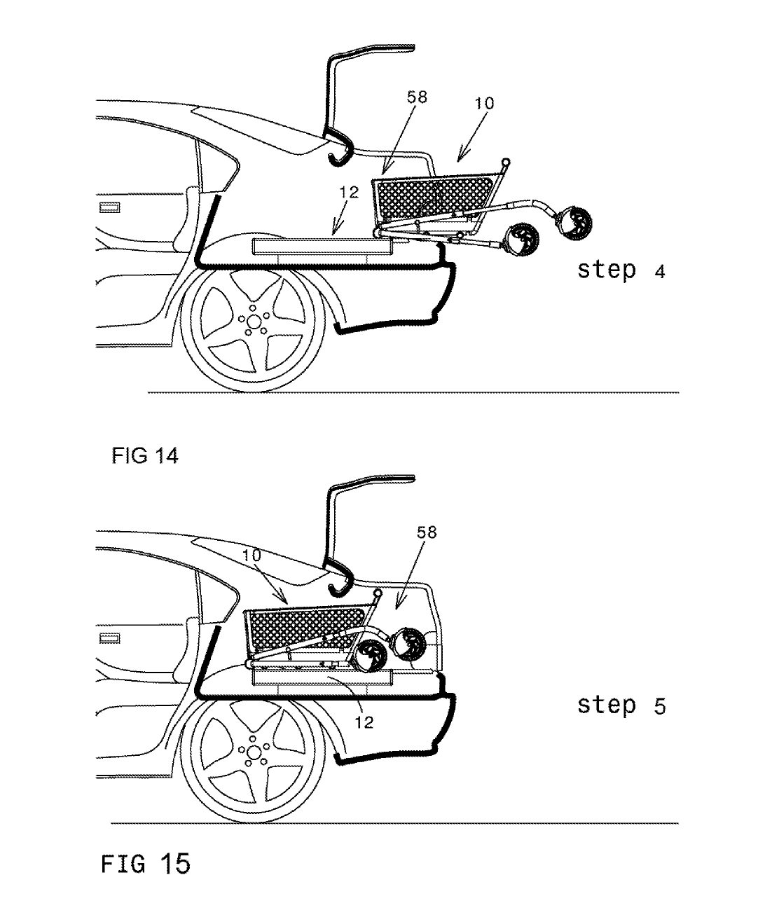

FIG. 14 is a side view of the shopping cart of FIG. 1, at the fourth step, regarding the embodiment of FIG. 11.

At the fourth step, the user further presses shopping cart 10 into vehicle 50 along top surface 92 of height compensating accessory 12, completing the folding of legs 18 and 20.

Wheels or cylinders 16, disposed at the bottom of basket support 70, may accompany the pressing of shopping cart 10 into vehicle 50.

FIG. 15 is a side view of the shopping cart of FIG. 1, at the fifth step, regarding the embodiment of FIG. 11.

At the fifth step, the user further presses shopping cart 10 into rear compartment 58 of vehicle 50 along top surface 92 of height compensating accessory 12.

FIG. 16 is a top perspective view of the height compensating accessory alone, of FIG. 11.

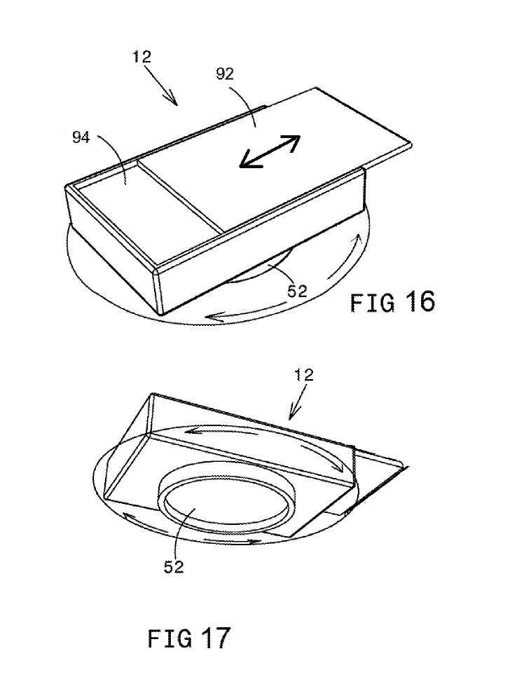

FIG. 17 is a bottom perspective view of the height compensating accessory alone, of FIG. 11.

According to one embodiment, height compensating accessory 12 includes a frame 94; a top surface 92, being slideable in relation to frame 94, as shown by the straight arrow; and a bottom rotatable base 52, being rotatable in relation to frame 94, for horizontally rotating frame 94, as shown by the round arrow.

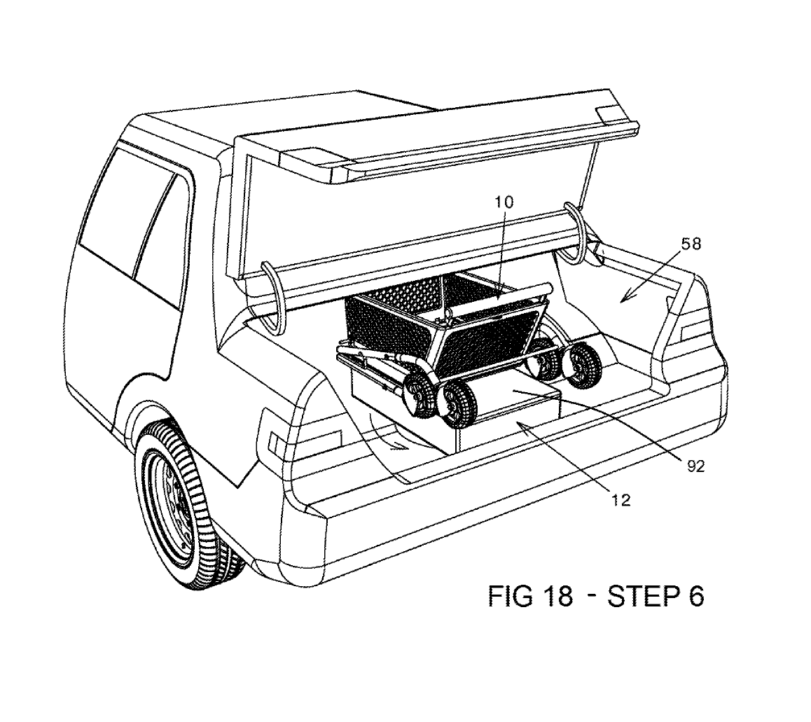

FIG. 18 is a perspective view of the shopping cart of FIG. 1, at the sixth step, regarding the embodiment of FIG. 11.

At the sixth step, the user further slides top surface 92 of height compensating accessory 12, together with shopping cart 10, supported thereby, into rear compartment 58 of vehicle 50 along top surface 92 of height compensating accessory 12.

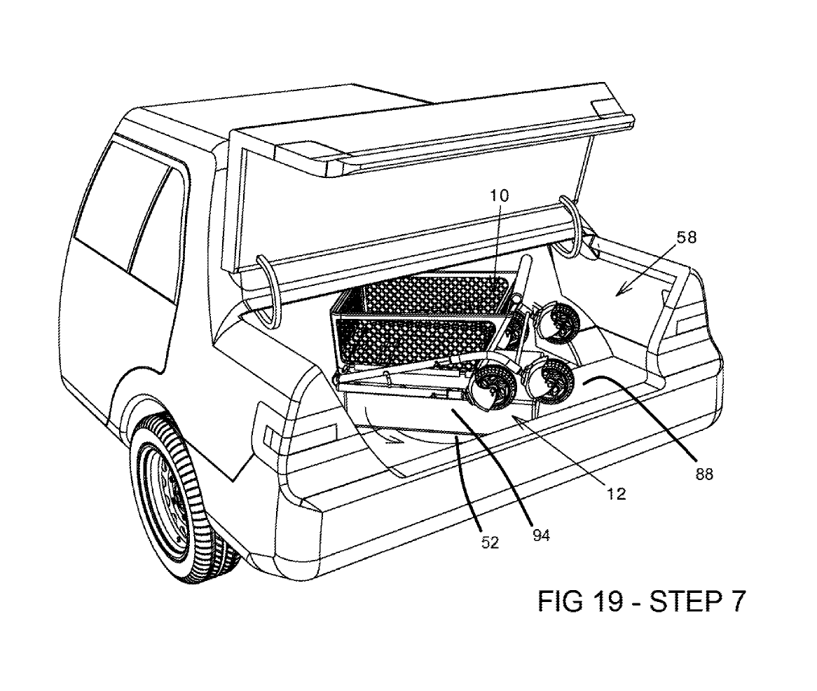

FIG. 19 is a perspective view of the shopping cart of FIG. 1, at the seventh step, regarding the embodiment of FIG. 11.

At the seventh step, the user may horizontally rotate frame 94 of height compensating accessory 12, together with shopping cart 10, supported thereby, in relation to rotatable base 52, for rotating shopping cart 10 in relation to bottom surface 88 of vehicle rear compartment 58.

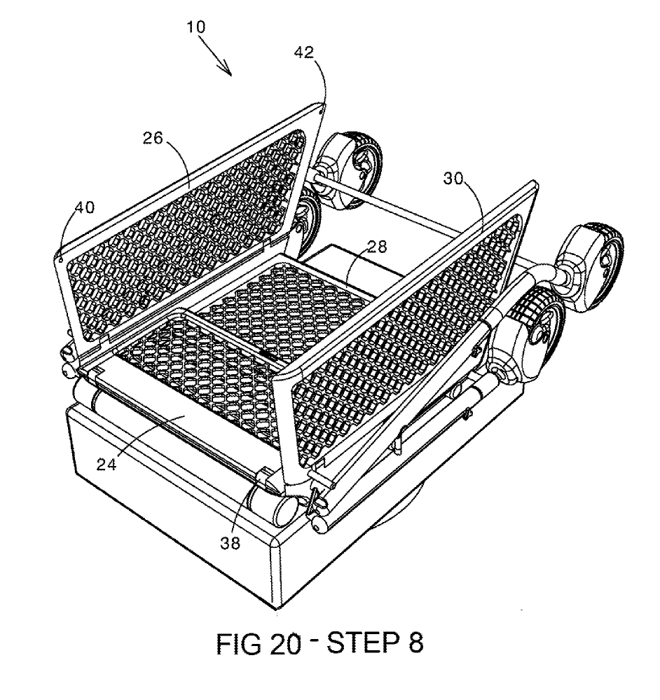

FIG. 20 is a perspective view of the shopping cart of FIG. 1, at the eighth step, regarding the embodiment of FIG. 11.

At the eighth step, the user may fold walls 24 and 28 of basket 78.

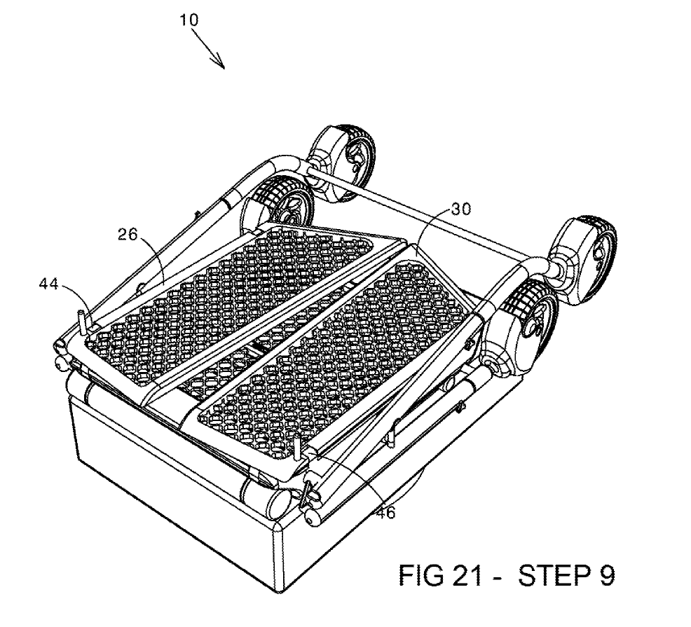

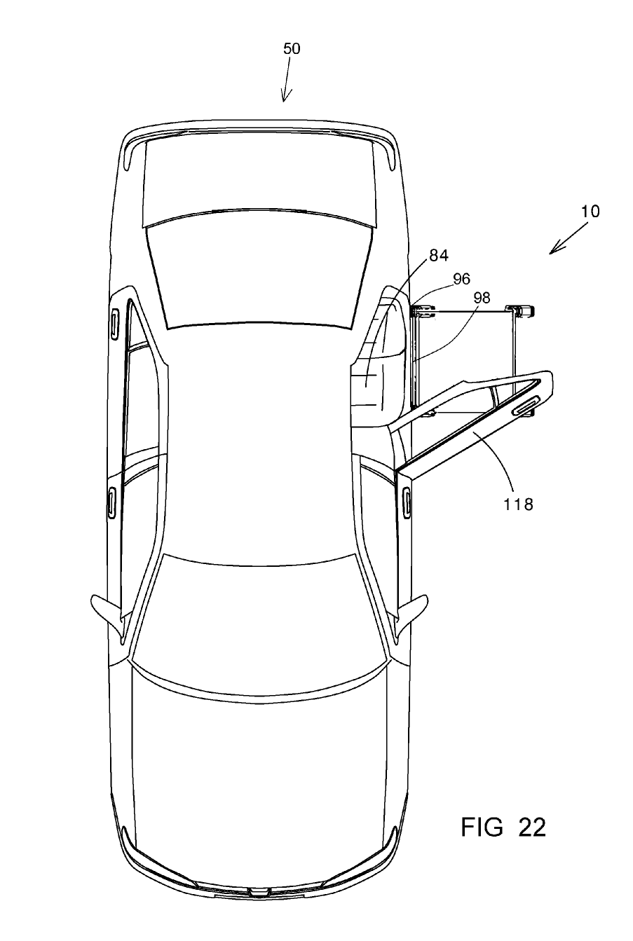

FIG. 21 is a perspective view of the shopping cart of FIG. 1, at the ninth step, regarding the embodiment of FIG. 11.

At the ninth step, the user may fold walls 26 and 30 of basket 78.

FIG. 22 is a top view, for depicting the problem of inserting the shopping cart of FIG. 1 through the side opening of the vehicle, depicted in FIG. 4.

Shopping cart 10 provides that upon vertically rotating legs 18 and 20, shopping cart 10 collapses into the vehicle 50.

FIG. 4 has described the insertion of shopping cart 10 into vehicle 50 through the side opening of the vehicle.

FIG. 5, has described that basket 78 of shopping cart 10 does not collapse on the ground, in spite of the folding of legs 18 and 20, since the vehicle seat 84 supports the bottom of shopping cart 10 including basket support 70 and legs 18; thus, shopping cart 10 collapses within the cabin of the vehicle.

However, this description is not accurate since the door 118 of the vehicle does not open to an angle of 90 degrees, but rather to about 60 degrees. Thus, corner 96 of shopping cart 10 does not face seat 84, and thus even the rest 98, which does face seat 84, cannot be placed within the vehicle above seat 84, for collapsing thereof onto seat 84.

This problem is valid only for basket 78, which maintains the height thereof in spite of the folding.

This problem is not valid to legs 18 and 20, which diminish the height thereof upon the folding.

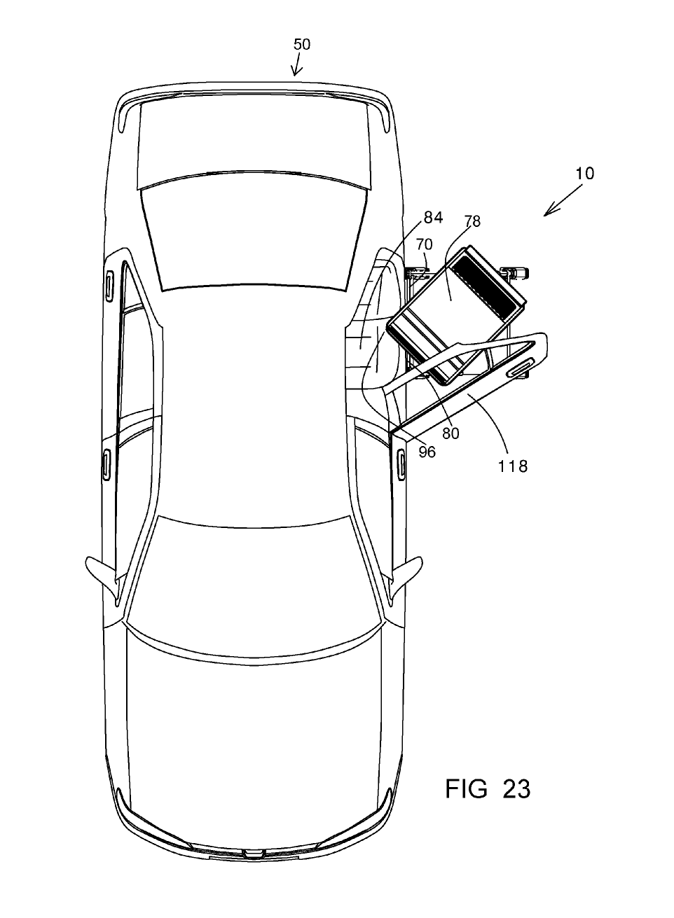

FIG. 23 is a top view depicting the solution to the problem of FIG. 22.

Thus, the solution to the problem is horizontally rotating basket 78 in relation to basket support 70 and to legs 18 and 20, for facing at least corner 96 of basket 78 within the vehicle, above seat 84.

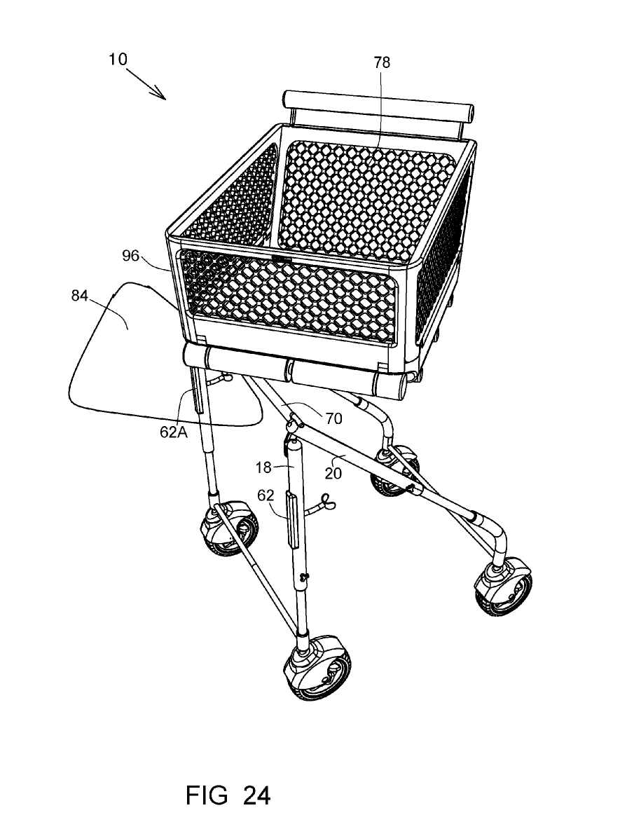

FIG. 24 is a perspective view of the cart of FIG. 23.

Thus, at the first step, legs 18 are placed adjacent to the side of vehicle 50.

At the second step, basket 78 is rotated in relation to basket support 70, for placing corner 96 above seat 84.

At the third step, even though button 62A of the leg below corner 96 cannot be pressed, button 62A indeed is pressed by sidewall 80 (indicated in FIG. 23) of the vehicle, and all legs 18 and 20 collapse.

At the fourth step, the bottom of basket 78, at least below corner 96 falls on seat 84.

At the fifth step, the user may push basket 78 further into the vehicle, while the collapsed legs 18 and 20 further fold.

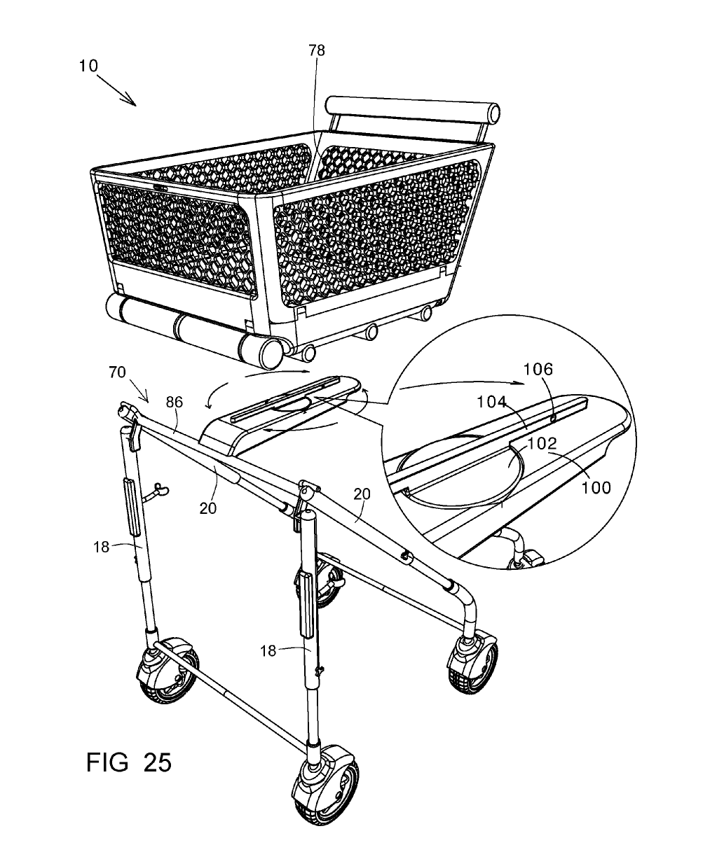

FIG. 25 is a top perspective view of a mechanism for rotating the basket in relation to the basket support.

Legs 18 and 20 support basket 78 through basket support 70. Legs 18 and 20 are rotatable in relation to basket support 70.

Legs 18 and 20 typically must extend from the front of shopping cart 10. Thus basket support 70 includes a horizontal bar 86 disposed at the front of shopping car 10, and legs 18 and 20 extend from horizontal bar 86.

Basket support 70 further includes a supporting arm 100 extending from horizontal bar 86, for supporting the center and rear of the bottom of basket 78.

Supporting arm 100 includes an arm 104, herein named “rotatable arm”, as it is rotatable by a rotatable table 102.

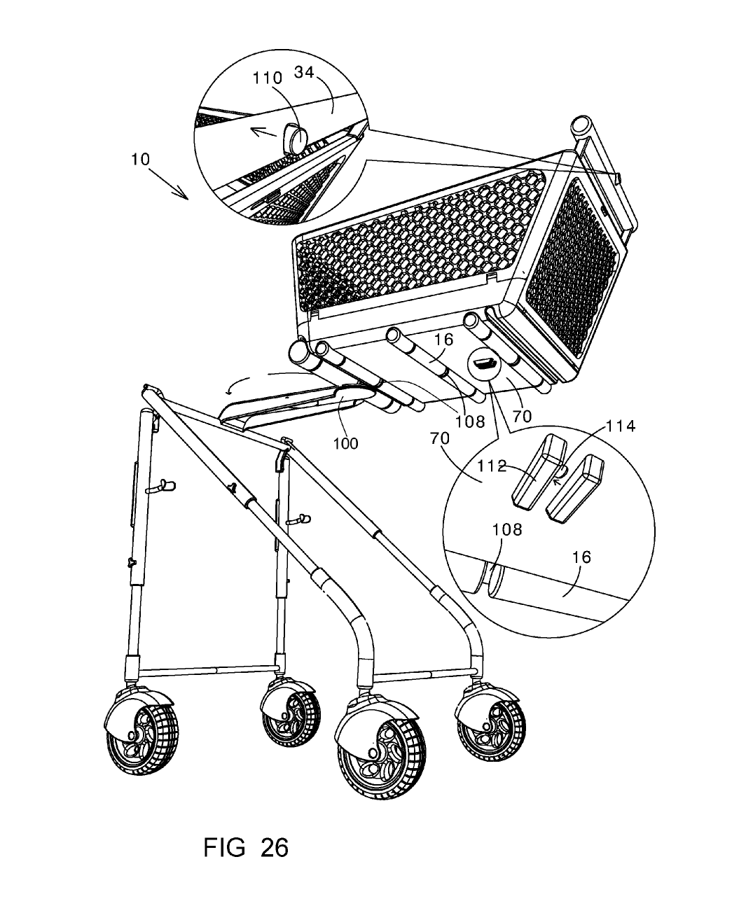

FIG. 26 is a bottom perspective view of the mechanism of FIG. 25.

Each of wheels 16 at the bottom of basket 78 includes a groove 108, for housing arm 104 (shown in FIG. 25). The bottom of basket 70 may include a lock 114, which may be moved by pressing a button 110, for inserting lock 114 into a depression 106 of supporting arm 100, shown in FIG. 25.

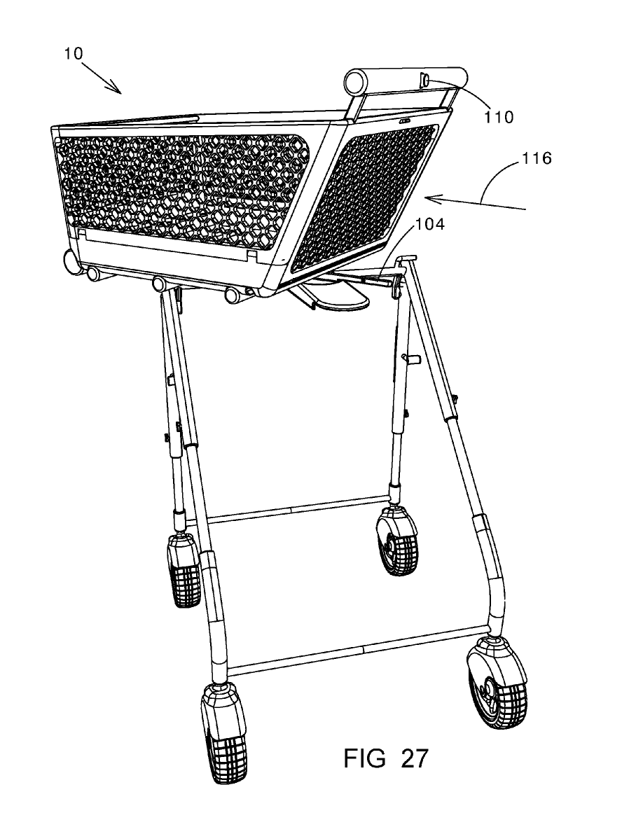

FIG. 27 depicts the functions of the mechanism of FIGS. 25 and 26.

Thus, rotatable arm 104 allows rotating basket 78 in relation to basket support 70, as depicted in FIG. 24, and also disassembling basket 78 from basket support 70 at the rotated state.

Referring again to FIG. 23, once pressing button 110, basket 78 may be rotated, for releasing it then from basket support 70.

Thus, in one aspect, the invention is directed to a cart (10) including:

a basket (78), being supported by a basket support (70), the basket (78) including side walls (24,26,28,30), for carrying contents;

legs (18,20) for sufficiently supporting the basket support (70), and extending therefrom, and being vertically rotatable in relation thereto;

at least one locking element (64), for locking the legs (18,20) to the basket support (70), for normally disallowing rotating the legs (18,20) in relation to the basket support (70), for normally maintaining the cart (10) unfolded; and

a mechanism (62), for canceling the locking,

thereby the vertical rotation of the legs (18,20) in relation to the basket support (70), is applicable upon the canceling of the locking,
thereby the cart (10) allows a single-step collapsing thereof.

The legs (18, 20) may extend from the front of the cart (10), wherein the carrying handle (34) of the cart (10) is disposed at the rear thereof.

The mechanism (62) for canceling the locking may be operable upon pressing horizontally on at least one of the legs (18,20),

thereby the vertical rotation of the legs (18,20) in relation to the basket support (70), is applicable upon pressing at least one of the legs (18,20) on an external wall (80) of the vehicle (50),
thereby the single-step collapsing of the cart (10) is automatically operable upon entrance into the vehicle (50).

The mechanism (62), for canceling the locking, upon pressing horizontally on at least one of the legs (18,20), may include:

a button (62) disposed on at least one of the legs (18,20); and

a locking element (64), for moving thereof by the button (62).

The cart (10) may be designed for entering the side opening of the vehicle, or the rear opening of the vehicle.

The legs (18,20) may be extendable, for allowing inserting the cart (10) either through the side opening of the vehicle or through a rear opening of the vehicle.

The cart (10) may further include:

wheels (14, 16) disposed at the bottom of the basket support (70) of the cart (10), for rolling the cart (10) thereon at the folded state.

The cart (10) may further include:

a height compensating accessory (12), for placing thereof on a bottom surface (88) of the rear compartment (58) of the vehicle (50), for placing the cart (10) on the height compensating accessory (12).

The basket (78) may be horizontally rotatable in relation to the basket support (70),

thereby allowing horizontal rotation of the basket (78) for entering at least the corner (96) thereof into the vehicle (50) prior to the collapsing of the cart (10).

The basket (78) may be removable from the basket support (70).

In another aspect, the invention is directed to a method for inserting a cart (10) into a vehicle (50), the method including the steps of:

vertically rotating legs (18,20) of the cart (10) in relation to a basket support (70) thereof, upon pressing at least one of the legs (18,20) on the external wall (80) of the vehicle (50); and

upon the vertical rotating, collapsing the cart (10) into the vehicle (50).

The step of vertically rotating the legs (18,20) may include releasing a locking element (64).

The method may further include the step of:

prior to the step of vertically rotating the legs (18,20) of the cart (10) in relation to a basket support (70) thereof, horizontally rotating the basket (78) in relation to the basket support (70),

thereby entering at least a corner (96) of the basket (78) into the vehicle (50) prior to the collapsing of the cart (10).

In the figures and/or description herein, the following reference numerals (Reference Signs List) have been mentioned:

numeral 10 denotes the shopping cart, according to one embodiment of the invention;

numeral 12 denotes a height compensating accessory, for disposing the shopping cart above the bottom surface of the passenger cabin;

numerals 14 and 16 denote wheels or cylinders for rolling thereon the shopping cart along the seat or along another internal horizontal surface within the passengers cabin or within the rear compartment of the vehicle;

numerals 18 and 20 denote legs of the shopping cart;

numeral 22 denotes a button for adjusting the height of the leg of the shopping cart;

numerals 24, 26, 28 and 30 denote side walls of the basket of the shopping cart;

numeral 32 denotes a button for folding walls of the basket;

numeral 34 denotes the carrying handle of the shopping cart; the carrying handle of conventional shopping carts is disposed at the rear of the shopping cart, for pushing the shopping cart thereby;

numeral 38 denotes a hinge, for folding a wall of the basket;

each of numerals 40 and 42 denotes a hole for inserting a pin thereinto, for locking adjacent perpendicular walls of the basket, one to the other;

numeral 44 denotes a hinge, for folding another wall of the basket;

numeral 46 denotes the rear wall of the vehicle;

numeral 50 denotes the vehicle, into which the shopping cart is inserted;

numeral 52 denotes a bottom rotatable base of the height compensating accessory;

numeral 54 denotes a hook disposed on one leg, for leaning thereon another leg;

numeral 58 denotes the rear compartment of the vehicle;

numeral 62 denotes a button for folding the shopping cart; button 62 preferably is pressed by the wall of the vehicle, upon drawing the cart thereto;

numeral 64 denotes a locking element or a pin for locking a leg of the shopping cart, for not allowing folding thereof;

numeral 66 denotes a bar extending from the basket support of the shopping cart;

numeral 68 denotes a hinge;

numeral 70 denotes the basket support of the shopping cart;

numeral 72 denotes a wheel of the shopping cart;

numeral 74 denotes a spring;

numeral 78 denotes the basket of the shopping cart;

numeral 80 denotes a side wall or another substance of the vehicle being pressed by the leg of the shopping cart upon drawing the shopping cart towards the vehicle;

numeral 82 denotes the ground;

numeral 84 denotes the vehicle seat;

numeral 86 denotes a horizontal bar of the basket support;

numeral 88 denotes the bottom surface of the rear compartment of the vehicle;

numeral 90 denotes the bottom of the opening of the rear compartment of the vehicle;

numeral 92 denotes the top surface of the height compensating accessory;

numeral 94 denotes the frame of the height compensating accessory;

numeral 96 denotes the corner of the shopping cart;

numeral 98 denotes the front of shopping cart, except for the corner thereof;

numeral 100 denotes an arm for supporting the center and rear of the basket;

numeral 102 denotes a rotatable table;

numeral 104 denotes a rotatable arm;

numeral 106 denotes a depression, for locking the basket;

numeral 108 denotes a groove;

numeral 110 denotes a button, for manually releasing the basket from the basket support;

numeral 114 denotes a lock; and

numeral 118 denotes the vehicle door.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A cart comprising:
a basket, being supported by a basket support, said basket comprising side walls, for carrying contents;
legs for sufficiently supporting said basket support, and extending therefrom, and being vertically rotatable in relation thereto;
at least one locking element, for locking said legs to said basket support, for normally disallowing rotating said legs in relation to said basket support, for normally maintaining said cart unfolded; and
a mechanism, for canceling said locking,
wherein said legs extend from a front of said cart, wherein a carrying handle of said cart is disposed at a rear thereof.
thereby the vertical rotation of said legs in relation to said basket support, is applicable upon said canceling of said locking,
thereby said cart allows a single-step collapsing thereof.

2. A cart according to claim 1, wherein said mechanism for canceling said locking, is operable upon pressing horizontally on at least one of said legs,
thereby the vertical rotation of said legs in relation to said basket support, is applicable upon pressing at least one of said legs on an external wall of a vehicle,
thereby said single-step collapsing of said cart is operable upon entrance into the vehicle.

3. A cart according to claim 2, wherein said mechanism, for canceling said locking, upon pressing horizontally on at least one of said legs, comprises:
a button disposed on said at least one of said legs; and
a locking element, for moving thereof by said button.

4. A cart according to claim 1, being designed for entering a member selected from a group consisting of: a side opening of the vehicle, a rear opening of the vehicle.

5. A cart according to claim 1, wherein said legs are extendable, for allowing inserting said cart either through a side opening of the vehicle or through a rear opening of the vehicle.

6. A cart according to claim 1, further comprising:
wheels disposed at a bottom of said basket support of said cart, for rolling said cart thereon at a folded state.

7. A cart according to claim 1, further comprising:
a height compensating accessory, for placing thereof on a bottom surface of a rear compartment of the vehicle, for placing said cart on said height compensating accessory.

8. A cart according to claim 1, wherein said basket is horizontally rotatable in relation to said basket support,
thereby allowing horizontal rotation of said basket for entering at least a corner thereof into the vehicle prior to the collapsing of said cart.

9. A cart according to claim 1, wherein said basket is removable from said basket support.
